(19) United States
(12) Patent Application Publication
(10) Pub. No.: US 2005/0269819 A1
(43) Pub. Date: Dec. 8, 2005

(54) Packaging with embedded security measures

(76) Inventor: James D. Chambers, Lawrenceville, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/137,083

(22) Filed: May 25, 2005

Related U.S. Application Data
(63) Continuation-in-part of application No. 10/961,866, filed on Oct. 7, 2004.
(60) Provisional application No. 60/509,177, filed on Oct. 7, 2003.

(51) Int. Cl. G09C 3/00

(52) U.S. Cl. 283/74

(57) ABSTRACT

A package for articles such as consumer goods that comprised security measures embedded within the package itself in order determine authenticity of goods is described. The package preferably comprises a packaging substrate material laminated to a face sheet having the security measures. The package may be printed with graphical indicia. The package may be authenticated by viewing the security measures, which may preferably be visible only under infrared light.

### CROSS REFERENCE TO RELATED APPLICATION

This application is a continuation-in-part of U.S. application Ser. No. 10/961,866 entitled “Packaging with Embedded Security Measures” filed on Oct. 7, 2004, the contents of which are incorporated by reference, which claims the benefit of U.S. Provisional Application No. 60/509,177 filed on Oct. 7, 2003.

### FIELD OF THE INVENTION

Certain embodiments of the present invention relate to packaging materials with embedded security measures, and more specifically to a multi-layer laminate of paperboard containing authentication mechanisms which may be used to develop secure packaging.

### BACKGROUND

Technology advances and the lowering of trade barriers continually enhance the growing global economy. Such growth has led to increased traffic of consumer goods through international trade channels. However, with the increase of consumer good traffic, problems have arisen with gray market goods, criminal subversion, and/or counterfeiting.

Often when crossing international borders, goods are stopped for inspection by local customs authorities. The United States Customs Department allows for U.S. registered trademark holders to record trademarks with the customs authority. When goods bearing the recorded mark or a mark substantially similar to the recorded mark enter the United States, they are stopped by the customs authority and inspected for authenticity. The sophistication of counterfeit goods and the existence of gray market goods and parallel imports has made it difficult for customs inspectors to determine which goods are authentic and which are not. Therefore, many manufacturers and trademark holders have turned to security measures associated with their product packaging and branding strategies to ensure authenticity of goods.

Recent methods of authentication of product packaging and brand protection have focused on adding authentication mechanisms to existing product packaging. These attempts at authentication include the use of labels or seals that are applied to the product packaging containing a security identifier. One example of such a security mechanism is the use of a hologram as an identifier of authenticity. Holograms may be applied on an adhesive label which can be placed on the product packages.

Current authenticity techniques are not foolproof, however, as sophisticated counterfeiters have developed techniques to copy security labels as well. Other problems arise during customs inspections, requiring customs officials to inspect each individually labeled product. If the products are on a shipping pallet and not labeled in a manner easily inspectable by a customs official, the pallet may have to be completely unpacked in order to examine each security authentication label, requiring substantial time and effort on the part of customs officials.

Other attempts to prevent counterfeiting of packaged consumer goods include the use of security paper having certain security features, such as unique identifiers, as part of the packaging itself. However, security paper, which has a thickness of 0.002 inches and a weight of 28 to 30 lbs per ream, has been found to be too thin for use with most packaging. Problems occur during the package converting process as well as during handling of such packaging which may compromise the appearance of the packaging. The use of security paper also requires the gravure printing process in order to apply graphical indicia, such as trademarks and other product identifiers, to the packaging which is a process not commonly used by packaging converters.

### SUMMARY

According to certain embodiments of the invention, a package comprises embedded security measures that readily allow authenticity of the packaged goods to be determined. Preferably, security measures, such as taggants or security threads, are embedded into a face sheet that is attached to the packaging substrate material used for forming the package. The face sheet is preferably paper having a refined surface. The security measures embedded in the face sheet are preferably only visible under infrared light. Graphical indicia may be printed on the packaging so that it appears no different than any other type of package. The packaged goods can be quickly examined for authenticity by passing at least a portion of the package under infrared light and viewing the security elements. The package may also be authenticated by the infrared light reader making an audible sound indicating the goods are authentic, if desired.

According to certain embodiments of the invention, the package may be authenticated using a chemical pen. The chemical pen is used to mark the package and reacts with the face sheet to preferably create a temporary marking. As the chemical evaporates, the mark preferably disappears and the goods can be determined as authentic. The packaging therefore maintains its original appearance after being authenticated. The face sheet used to form the packaging and the chemical pen can be selected to create a specific color when the package is marked. If the chemical pen makes a mark of a different color than the one specified, or no mark at all, it can readily be determined that the goods are not authentic.

### BRIEF DESCRIPTION OF THE DRAWINGS

FIG. 1 is a perspective view of a package according to certain embodiments of the invention under a infrared light.

### DETAILED DESCRIPTION

In order to more effectively prevent counterfeiting of goods and identification of gray market goods, certain embodiments of the present invention comprise embedded security measures in a face sheet used to form the packaging itself. By incorporating security measures into the package 10, the entire package serves as the authentication device. Such packaging is preferably easily inspectable and recognizable as authentic.

According to certain embodiments of the present invention, it is preferable to inject security authentication measures directly into a face sheet. The face sheet is preferably a type of paper with a very refined surface such as label stock. The face sheet preferably ranges from 0.003 inches to 0.0042 inches thickness and from 55 lbs to 62 lbs per ream. These attributes of the face sheet make it preferable for laminating to a packaging substrate and substantially durable during the package converting process. The face sheet also is able to withstand handling of the package throughout the supply chain, from manufacture to retail, while maintaining an attractive appearance. Thus, the use of the face sheet to form secure packaging for consumer goods provides a refined package that both resists counterfeiting attempts and is appealing to consumers.

The face sheet may be placed on top of a packaging substrate such as paperboard, fiberboard, chip board, corrugated as well as others and preferably laminated. In order to laminate the face sheet to the packaging substrate of choice, both the face sheet and the packaging substrate are unwound from large industrial rolls and adhered together, preferably by polyvinyl acetate (PVA) or polyurethane. This process forms a sheet or roll of finished material that can be used to form product packaging using conventional techniques by a packaging converter. The laminated substrate and face sheet may be used to form product packaging of any type.

Many consumer products are packaged using paperboard and corrugated materials. Such materials are typically formed in large sheets which may be cut to size in order to form the desired package. The face sheet, which is preferably applied to the packaging substrate, is formed at conventional paper mills and the process of producing a face sheet is well-known. According to certain embodiments of the present invention, it is preferable to produce the face sheet with the authentication measures embedded within. This is preferably done by introducing the authentication measures into the face sheet production process. Such authentication measures or elements may include embedded threads or taggants 15. The face sheet, therefore, is preferably produced having the security threads and/or taggants embedded directly within.

The impact of counterfeiting is largely felt by manufacturers of brand oriented consumer goods. These goods are often packaged in a container having a unique combination of brand identifiers, colors and graphics. In some cases, these features of the packaging may be the primary methodology used by consumers to recognize desired products and selecting them for purchase. According to certain embodiments of the invention, the face sheet used to form the packaging may be printed with multi-color graphics 18 using standard printing techniques, such as offset lithography printing, commonly used by packaging converters, if desired. Such printing may involve the use of oil based inks which the face sheet according to certain embodiments of the invention can accommodate.

Once the face sheet has been produced, it can preferably be applied to a paperboard sheet of approximately the same dimension and laminated using standard lamination techniques. The resulting sheet of packaging board comprises security authentication measures within the material itself. The sheet of packaging board can be cut as desired and used to form product packaging of various designs. Such packaging would include, but is not limited to, packaging for automotive parts, cigarettes, liquor, compact disks, DVD's, cosmetics, pharmaceuticals, and other goods known as fast-moving consumer goods.

According to certain embodiments of the present invention, the packaging board with embedded security mechanisms can be used to form any type of product packaging. Typically, the materials will be used to form a carton of some sort.

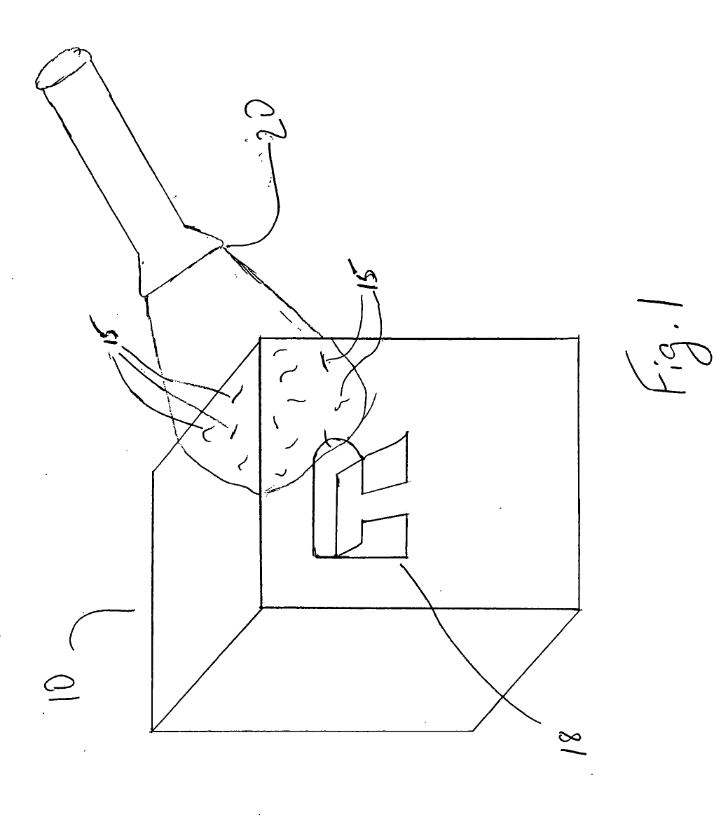

According to certain embodiments, the security mechanisms, such as threads, fibers and/or taggants, may preferably be visible only under infrared light 20, as shown in FIG. 1. Such security mechanisms may preferably not be visible under white light, ultraviolet light or any other type of light. The security mechanisms may be embedded into the face sheet of the packaging board used to form the package. According to certain embodiments, the security mechanisms embedded in the face sheet may be coded data, which can be read by machine. The coded data may provide either general or specific authentication information as described above. The security mechanisms may also be used to authenticate packaged product simply by being embedded in the face sheet of the packaging material, without forming any coded data. As such, the security mechanisms would not be visible under ordinary white light, but when subjected to infrared light, the security mechanisms will appear, indicating that the packaging is authentic. A standard infrared light reader, such as Stardust Technology IR reader, can be used to authenticate packaging according to certain embodiments of the invention, whether the security mechanisms are coded or not.

According to certain embodiments, the security mechanism embedded in the packaging may provide an audible authentication mechanism. It is preferable that the security mechanisms are not visible under white light. In order to authenticate the packaging, the packaging may preferably be placed under infrared light. The infrared light is reflected off the security mechanisms and the infrared reader recognizes the frequency of the reflected light. Once the reader recognizes the frequency, it compares the frequency to stored data including sounds that correlate to different frequencies. The reader selects the appropriate sound based on the recognized light frequency and creates an audible sound that is recognizable to the user, authenticating the package. Such readers may be purchased from Stardust Technology. In the event the reader does not recognize the frequency of light being reflected from the packaging, the reader may make a different sound that indicates the packaging is not authenticate or alternatively the reader may make no sound at all. It should be understood that the sound made by the reader may be a single note, a series of notes, or a verbal message indicating whether the packaging is authentic or not.

Taggants may preferably provide additional security measures for fraud prevention according to certain embodiments of the present invention. Taggants which may be embedded into the face sheet of the packaging board are invisible to the human eye. However, when viewed under ultraviolet light, taggants may become visible in various colors. Color combinations of taggants may be used by manufacturers to develop authentication codes.

According to certain embodiments of the invention, the face sheet used to form packaging may comprise a security mechanism that reacts with a chemical pen to preferably create a temporary ink mark on the packaging. The ink mark will preferably remain on the surface of the packaging until the ink evaporates at which time the mark disappears. The packaging, thus, remains unaltered and attractive to the consumer but can still be authenticated. Such face sheet material and chemical pens are commercially available from Appleton Ideas, such as Appleton Pentick Plus.

It should be understood that the color of the pen can be specifically selected to mate with the particular face sheet material to create a unique color for authentication of goods. If, for example, a customs agent marks the packaging with a pen and a color other than the unique authenticating color or no color at all appears, the customs agent will be able to determine the goods are counterfeit.

According to certain embodiments, the pen may make a permanent mark on the packaging if desired. The color of the mark may be an authentication identifier by selecting a specific combination of chemical pen and face sheet material which creates a mark on the package of a specific color, identifying the goods as authentic. If the mark made by the pen is of a different color, the goods maybe identified as counterfeit.

The packaging according to certain embodiments of the present invention allow easy identification of authentic goods. In particular, by placing the authentication mechanisms throughout the packaging board, any portion of the package can be inspected for authentication purposes. For example, customs officials may inspect an entire shipping pallet of packaged products for authentication purposes by examining any portion of the packaged product, eliminating the need to unpack the entire pallet in the event authentication labels are not easily accessible. Gray market goods may also be identified by embedding machine readable codes into the face sheet of the packaging board which identifies attributes of the packaged goods such as manufacturing location or licensed territory. According to certain embodiments, the packaging can be authenticated multiple times along the supply chain without any alteration to the packaging.

1. A blank of material for creating a package, comprising:
a plurality of laminates comprising, at least on packaging substrate and at least one face sheet;
the face sheet comprising security mechanisms embedded within the face sheet, wherein the security mechanisms are visible only under infrared light;
wherein graphical indicia is capable of being printed on the blank of material.

2. The blank of material of claim 1 wherein the security mechanisms are taggants.

3. The blank of material of claim 1, wherein the security mechanisms are security threads.

4. The blank of material of claim 1, wherein the security mechanisms are fibers.

5. The blank of material of claim 1, wherein the face sheet is between approximately 0.003 inches and 0.0042 inches thick.

6. The blank of material of claim 1, wherein the face sheet is between approximately 55 and 62 lbs per ream.

7. The blank of material of claim 1, wherein an audible sound is created when subjected to an ultraviolet light reader.

8. The blank of material of claim 7, wherein the audible sound is a verbal message.

9. The blank according to claim 1, wherein the packaging substrate is paperboard.

10. The blank according to claim 9, further comprising polyvinyl acetate attaching the face sheet to the packaging substrate.

11. A package comprising:
security mechanisms as part of the packaging material, wherein the package may be authenticated by subjecting the package to the light of an infrared reader which makes an audible sound if the frequency of the reflected light from the security mechanisms is recognized.

12. The package of claim 11 further comprising a base packaging material and a face sheet comprising the security mechanisms.

13. The package of claim 12, wherein the face sheet is laminated to the base packaging material.

14. The package of claim 13, wherein the face sheet is attached to the base packaging material using poly vinyl acetate.

15. The package of claim 11, wherein the security mechanisms are taggants.

16. The package of claim 11 wherein the security mechanisms are not visible under white light.

17. A method of authenticating a package comprising:
providing a package comprising security features;
subjecting the package to infrared light using an infrared light reader;
wherein the infrared light is reflected off the security features and the infrared light reader recognizes the frequency of the reflected light and compares the recognized frequency to stored frequency values each corresponding to an audible sound, the infrared light reader capable of making a sound corresponding to a recognized frequency; and
hearing the sound made by the infrared light reader in order to determine the authenticity of the package.

18. The method of claim 17, wherein the security features are taggants.

19. The method of claim 17, wherein the security features are embedded in a face sheet which is laminated to the packaging substrate material.

20. The method of claim 17 wherein the package comprises paperboard.

21. The method of claim 17, wherein the package comprises corrugated.

22. A blank of material for creating a package comprising:
a base packaging material and a face sheet attached to the base packaging material;
wherein a package formed from the blank will exhibit an ink mark when marked using a chemical pen.

23. The blank of material of claim 22, wherein the ink mark is permanent.

24. The blank of material of claim 22, wherein the face sheet and the chemical pen can be selected in combination to exhibit a mark of a specific color when the package is marked using the pen.

25. The blank of material of claim 22, wherein the base packaging material comprises paperboard or fiberboard.

26. The blank of material of claim 22, wherein the base packaging material comprises corrugated.
